(19) United States
(12) Patent Application Publication
(10) Pub. No.: US 2025/0348982 A1
(43) Pub. Date: Nov. 13, 2025

(54) DISPLAY VIDEO CORRECTION DEVICE, DISPLAY VIDEO CORRECTION METHOD, AND RECORDING MEDIUM

(71) Applicant: Nuvoton Technology Corporation Japan, Kyoto (JP)

(72) Inventor: Takashi KAMIUNTEN, Kanagawa (JP)

(21) Appl. No.: 19/275,310

(22) Filed: Jul. 21, 2025

Related U.S. Application Data
(63) Continuation of application No. PCT/JP2024/002091, filed on Jan. 24, 2024.
(60) Provisional application No. 63/443,131, filed on Feb. 3, 2023.

(51) Int. Cl. G06T 5/80; G06T 3/40; G06T 5/50; G06T 7/73

(52) U.S. Cl. CPC G06T 5/80; G06T 3/40; G06T 5/50; G06T 7/74; G06T 2207/10016; G06T 2207/20061; G06T 2207/30252

(57) ABSTRACT

A display video correction device includes: a feature extractor that extracts a feature from a camera image obtained from an in-vehicle camera; a Hough transformer that performs Hough transform on the feature extracted; a straight line detector that detects a plurality of straight lines in the camera image, based on a transform result of the Hough transform performed; a vanishing point calculator that calculates, based on the plurality of straight lines detected, first coordinates indicating coordinates of a vanishing point in the camera image; a difference calculator that calculates a difference between the first coordinates calculated and predetermined second coordinates; and a position corrector that corrects, based on the difference calculated, a position of a display area in the camera image to be displayed on a display device.

### CROSS REFERENCE TO RELATED APPLICATIONS

This is a continuation application of PCT International Patent Application No. PCT/JP2024/002091 filed on Jan. 24, 2024, designating the United States of America, which is based on and claims priority of U.S. Provisional Patent Application No. 63/443,131 filed on Feb. 3, 2023. The entire disclosures of the above-identified applications, including the specifications, drawings and claims are incorporated herein by reference in their entirety.

### FIELD

The present disclosure relates to a display video correction device, a display video correction method, and a recording medium.

### BACKGROUND

Devices that calibrate in-vehicle cameras have been conventionally available. For example, Patent Literature (PTL) 1 discloses a camera mounting error correction device that corrects a mounting error of a camera attached to a vehicle. Moreover, PTL 2 discloses an in-vehicle camera self-calibration method.

In addition to the above, devices that perform image processing on images obtained from in-vehicle cameras have been conventionally available. For example, PTL 3 discloses a driving support device that processes an image signal output from an image capturing means such that a driving support display made up of predetermined graphics is superimposed on an image captured by the image capturing means provided in a vehicle.

### CITATION LIST

### Patent Literature

PTL 1: Japanese Unexamined Patent Application Publication No. 2014-59793
PTL 2: Japanese Unexamined Patent Application Publication (Translation of PCT Application) No. 2021-513247
PTL 3: Japanese Unexamined Patent Application Publication No. 2012-74777

### SUMMARY

### Technical Problem

In-vehicle cameras are used by, for example, drivers of vehicles, operators who remotely control vehicles, etc., to check surroundings of the vehicles. Along with a growing number of electric vehicles (EV) in recent years, more and more vehicles are provided with camera monitoring systems. Accordingly, ensuring the field of view of in-vehicle cameras included in camera monitoring systems is becoming more and more important for the application of the camera monitoring systems to be provided in vehicles.

Here, the positions and orientations in which these in-vehicle cameras have been initially attached to the vehicles may change due to deterioration over time, etc. Moreover, depending on the number of people in vehicles, the positions and orientations of these in-vehicle cameras may move due to weights of the people. The foregoing may cause the in-vehicle cameras to capture locations different from locations initially planned to be captured, causing display devices to show the locations different from the initially planned locations.

The present disclosure provides a display video correction device, etc., which are capable of readily correcting camera images obtained from an in-vehicle camera.

### Solution to Problem

A display video correction device according to one aspect of the present disclosure includes: a feature extractor that extracts a feature from a camera image obtained from an in-vehicle camera; a Hough transformer that performs Hough transform on the feature extracted; a straight line detector that detects a plurality of straight lines in the camera image, based on a transform result of the Hough transform performed; a vanishing point calculator that calculates, based on the plurality of straight lines detected, first coordinates indicating coordinates of a vanishing point in the camera image; a difference calculator that calculates a difference between the first coordinates calculated and predetermined second coordinates; and a position corrector that corrects, based on the difference calculated, a position of a display area in the camera image to be displayed on a display device.

A display video correction method according to one aspect of the present disclosure includes: extracting a feature from a camera image obtained from an in-vehicle camera; performing Hough transform on the feature extracted; detecting a plurality of straight lines in the camera image, based on a transform result of the Hough transform performed; calculating, based on the plurality of straight lines detected, first coordinates indicating coordinates of a vanishing point in the camera image; calculating a difference between the first coordinates calculated and predetermined second coordinates; and correcting, based on the difference calculated, a position of a display area in the camera image to be displayed on a display device.

A non-transitory computer-readable recording medium according to one aspect of the present disclosure is a non-transitory computer-readable recording medium for use in a computer. The recording medium has recorded thereon a computer program for causing the computer to execute the above-described display video correction method.

### Advantageous Effects

The display video correction device, etc., according to the present disclosure are capable of readily correcting camera images obtained from an in-vehicle camera.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a configuration of a display video correction device according to Embodiment 1.

FIG. 2 is a diagram for explaining a camera image according to Embodiment 1.

FIG. 3 is a diagram for explaining a feature according to Embodiment 1.

FIG. 4 is a flowchart illustrating a display video correction method according to Embodiment 1.

FIG. 5 is a block diagram illustrating a configuration of a display video correction device according to Embodiment 2.

FIG. 6 is a diagram for explaining example 1 of an origin point change according to Embodiment 2.

FIG. 7 is a diagram for explaining example 2 of the origin point change according to Embodiment 2.

FIG. 8 is a diagram for explaining example 3 of the origin point change according to Embodiment 2.

FIG. 9 is a block diagram illustrating a configuration of a display video correction device according to Embodiment 3.

FIG. 10 is a block diagram illustrating a configuration of a display video correction device according to Embodiment 4.

### DESCRIPTION OF EMBODIMENTS

Hereinafter, embodiments will be described in detail with reference to the drawings.

Note that the embodiments below each describe a general or specific example. The numerical values, shapes, materials, elements, the arrangement and the connection of the elements, steps, orders of the steps etc., illustrated in the following embodiments are mere examples, and are not intended to limit the present disclosure. Furthermore, among the elements in the embodiments below, those not recited in any one of the independent claims representing the most generic concepts will be described as optional elements.

Moreover, in the present specification, ordinal numbers such as “first”, “second”, and so on do not indicate the number of elements or the order of elements unless otherwise indicated. The purposes of using ordinal numbers are to avoid confusion with one another and to distinguish between elements of the same type.

### Embodiment 1

### [Configuration]

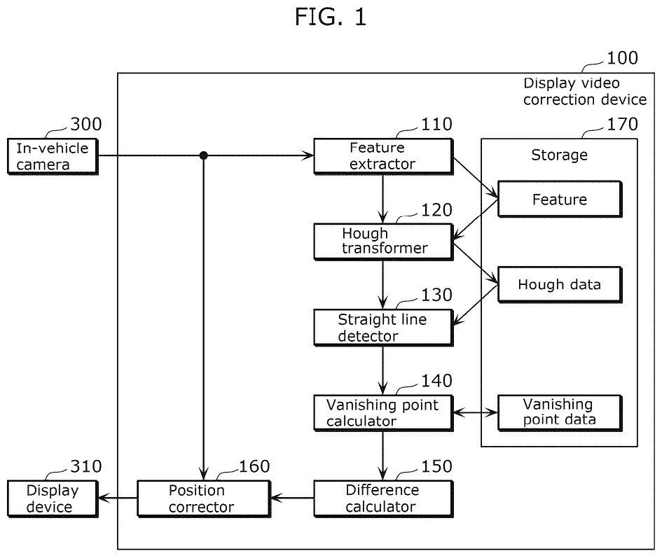

FIG. 1 is a block diagram illustrating a configuration of display video correction device 100 according to the present embodiment.

Display video correction device 100 is a computer that determines a display area in camera images to be displayed on display device 310. The camera images are obtained from in-vehicle camera 300. Display video correction device 100 is implemented by, for example, a communication interface for communicating with in-vehicle camera 300 and display device 310, nonvolatile memory that stores programs, volatile memory that is a transitory storage area for executing the programs, an input/output port for receiving and transmitting signals, and a processor that executes the programs. The communication interface may be implemented by, for example, (i) an antenna and a wireless communication circuit so as to be capable of wireless communication or (ii) a connector to which a communication line is connected so as to be capable of wired communication. Display video correction device 100 is, for example, provided in a vehicle, but may be provided outside the vehicle.

In-vehicle camera 300 is a camera provided in a vehicle. In-vehicle camera 300 is attached to a vehicle so as to be capable of capturing surroundings of the vehicle, such as a front view and a rear view of the vehicle, for example. The vehicle is, for example, a motorcycle or an automobile, but may be a mobile robot such as an autonomous mobile robot (AMR). Moreover, the vehicle may be operated by a driver in the vehicle, may be remotely controlled, or may be capable of autonomous driving.

Display video correction device 100 obtains camera images generated by in-vehicle camera 300 capturing surroundings of a vehicle, determines a display area in the obtained camera images, and causes display device 310 to display camera images of the determined display area.

Display device 310 is a display that displays camera images. Display device 310 is, for example, provided in a vehicle, but may be provided outside the vehicle.

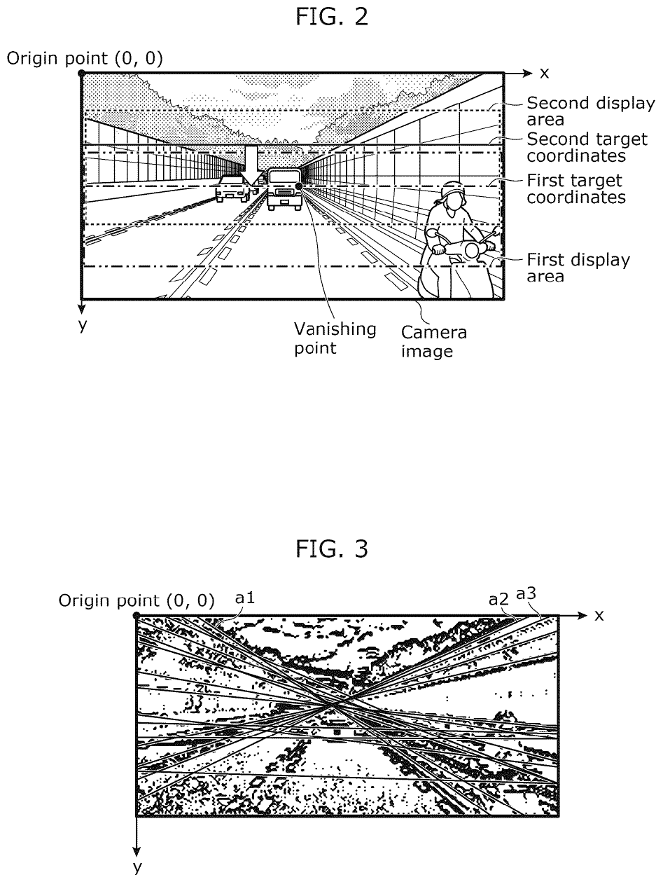

FIG. 2 is a diagram for explaining a camera image according to the present embodiment. The camera image schematically shown in FIG. 2 is one example of a camera image (image) captured (generated) by in-vehicle camera 300. Note that FIG. 2 shows an image coordinate system of the camera image using the x-axis and y-axis.

The image coordinate system is a two-dimensional orthogonal coordinate system consisting of the x-axis and y-axis which corresponds to camera images. Specifically, the image coordinate system is a coordinate system whose origin point is at the position of the upper left pixel of camera images, assuming that the entirety of each camera image is to be displayed on display device 310. In the image coordinate system, the positive direction of the x-axis is the rightward direction from the above-mentioned pixel, and the positive direction of the y-axis is the downward direction from the above-mentioned pixel. Note that the coordinate system whose origin point is at the position of the upper left pixel in camera images is also referred to as a first coordinate system.

For example, images of a second display area in camera images are initially set to be displayed on display device 310. In other words, not the entirety of camera images is set to be displayed on display device 310, but only camera images of an area enclosed by the second display area are initially set to be displayed on display device 310, for example. The second display area is, for example, optionally predetermined. Display video correction device 100 changes (corrects) the position of the above-mentioned second display area based on a predetermined condition, and causes display device 310 to display camera images of the changed display area (e.g., first display area shown in FIG. 2). Specifically, display video correction device 100 changes the position of a display area such that target coordinates to be set relative to the display area agrees with the coordinates of a vanishing point in a camera image. In the example shown in FIG. 2, display video correction device 100 shifts the position of the second display area to the first display area such that the second target coordinates (also referred to as second coordinates) are set at first target coordinates that coincide with the vanishing point, to correct the position of the display area. With this, only a camera image of an area enclosed by the first display area is to be displayed on display device 310.

As illustrated in FIG. 1, display video correction device 100 includes feature extractor 110, Hough transformer 120, straight line detector 130, vanishing point calculator 140, difference calculator 150, position corrector 160, and storage 170.

Feature extractor 110 is a processing unit that extracts features from camera images obtained from in-vehicle camera 300. Specifically, feature extractor 110 obtains a camera image from in-vehicle camera 300, and performs image processing on the obtained camera image to extract a feature of the camera image.

This feature is information indicating outlines of objects, etc., captured in a camera image. The feature is, for example, information containing feature points that make up the outlines. More specifically, the feature is information containing coordinates of each of the feature points.

FIG. 3 is a diagram for explaining a feature according to the present embodiment.

Feature extractor 110 uses, for example, the camera image shown in FIG. 2 as an input to output a feature (specifically, data indicating coordinates of each of feature points) shown in FIG. 3.

Note that a process to be performed by feature extractor 110 on a camera image to extract a feature may be an optional process. Feature extractor 110 extracts, as a feature, outlines in a camera image by performing, for example, filter processing such as the Sobel filter on the camera image.

Hough transformer 120 is a processing unit that performs Hough transform on a feature extracted from a camera image by feature extractor 110.

Hough transform is a process of converting a straight line that passes through a feature (feature point) into coordinates (ρ, θ) in Hough space by representing the straight line using ρ and θ, where ρ is the length of a perpendicular drawn from a reference point such as the origin point toward the straight line and θ is an angle formed by the perpendicular and a reference axis such as the x-axis at which the perpendicular passes through the reference point. The above-described straight line is innumerably present for each of feature points, and a set of ρ and θ that can uniquely identify each of these straight lines is represented by a curve (also referred to as Hough curve) according to the coordinates of a feature point in a ρ-θ plane (ρ-θ coordinate system) in Hough space (a space of a coordinate system consisting of an axis representing values of ρ and an axis representing values of θ). For example, each of straight lines that passes through a point (x, y) in the rectangular coordinate system (e.g., the coordinate system shown in FIG. 2) can be represented by (i) θ that is an angle formed by the x-axis and a perpendicular that intersects with the straight line at a right angle and (ii) ρ that is the length of the perpendicular. In Hough transform, ρs are calculated while changing θ. When there is a point shared by these curves in the ρ-θ plane, it is arranged on a single line in the original xy rectangular coordinate system. In other words, a location at which numerous Hough curves as described above overlap in the ρ-θ plane indicates ρ and θ representing a straight line that passes through numerous feature points. Accordingly, it can be said that the greater the number of overlapping Hough curves (also referred to as the number of votes or the number of votes cast), the more likely it is to be a straight line.

Straight line detector 130 is a processing unit that detects a plurality of straight lines in a camera image based on a transform result of a feature obtained by performing Hough transform on the feature by Hough transformer 120. Specifically, straight line detector 130 detects a straight line in a camera image based on the number of votes calculated from Hough curves indicated by the transform result. With this, a plurality of straight lines as shown in FIG. 3 are detected from the feature shown in FIG. 3.

Note that the number of votes to be detected as a straight line by straight line detector 130 may be optionally determined, and thus is not particularly limited. Moreover, the number of straight lines to be detected by straight line detector 130 may be predetermined. For example, based on the number of straight lines to be detected, straight line detector 130 may successively determine (detect) a plurality of straight lines in decreasing order of the number of votes.

In addition, the following information items may be determined for, for example, each of different areas in the ρ-θ plane: (i) first information indicating the minimum number of votes to be detected as a straight line by straight line detector 130 and/or (ii) second information indicating the number of straight lines to be detected by straight line detector 130. For example, straight line detector 130 detects a plurality of straight lines based on the number of votes calculated based on a transform result and at least one of (i) first information indicating the minimum number of votes to be detected as a straight line by straight line detector 130 or (ii) second information indicating the number of straight lines to be detected by straight line detector 130. The first information and second information have been determined for each of areas in the ρ-θ space of the transform result.

The first information is, as described above, threshold information indicating the minimum number of votes to be detected as a straight line by straight line detector 130. The first information indicates, for example, for each of the above-mentioned areas, a threshold (lower limit) for the number of votes to be detected as a straight line by straight line detector 130.

The second information indicates, as described above, the number of straight lines to be detected by straight line detector 130. Note that the second information may be a numerical value indicating the number of straight lines to be detected by straight line detector 130, may indicate the upper limit of the number of straight lines to be detected by straight line detector 130, may indicate the lower limit of the number of straight lines to be detected by straight line detector 130, or may indicate the range of the number of straight lines to be detected by straight line detector 130.

Vanishing point calculator 140 is a processing unit that calculates, based on a plurality of detected straight lines, first coordinates indicating the coordinates of a vanishing point in a camera image. For example, vanishing point calculator 140 calculates coordinates of the intersection point of two straight lines selected from among a plurality of straight lines detected by straight line detector 130 in a round-robin manner, to calculate the first coordinates based on the average of coordinates of a plurality of intersection points. As illustrated in FIG. 3, straight line detector 130 detects a plurality of straight lines such as straight line a1, straight line a2, and straight line a3. Vanishing point calculator 140 generates combinations of two straight lines among the plurality of straight lines detected by straight line detector 130 in a round-robin manner, like straight line a1 and straight line a2, straight line a1 and straight line a3, straight line a2 and straight line a3, and so on. Vanishing point calculator 140 calculates, for each of these combinations, coordinates of the intersection point of the two straight lines. Vanishing point calculator 140 calculates the average coordinates of the calculated intersection points as the coordinates of a vanishing point in a camera image, for example.

It should be noted that when two lines are selected in a round-robin manner, two lines approximately parallel to each other may be selected, for example. In view of the above, among combinations of two straight lines selected from among the plurality of straight lines in a round-robin manner, vanishing point calculator 140 calculates the coordinates of intersection points for only combinations of two straight lines having opposite reciprocal slopes in the image coordinate system of a camera image, where one of the two straight lines has the positive slope and the other of the two straight lines has the negative slope. Stated differently, in the image coordinate system of a camera image, vanishing point calculator 140 is to calculate the coordinates of the intersection point of two straight lines for only the two straight lines whose slopes differ by 90 degrees or more.

For example, among the plurality of straight lines shown in FIG. 3, vanishing point calculator 140 calculates intersection points for only straight lines extending from the upper left to the lower right and straight lines extending from the upper right to the lower left, and calculates, as the coordinates of the vanishing point, the average coordinates of the calculated intersection points. For example, vanishing point calculator 140 calculates, for example, the intersection point of (i) straight line a1 and straight line a2 and (ii) straight line a1 and straight lined a3, but does not calculate the intersection point of straight line a2 and straight line a3.

Note that vanishing point calculator 140 may use the moving average of coordinates of vanishing points to calculate coordinates of a vanishing point.

For example, vanishing point calculator 140 calculates coordinates of a vanishing point in the current camera image based on a plurality of detected straight lines, and calculates the first coordinates based on the coordinates of the vanishing point in the current camera image and the moving average of coordinates of the vanishing points in past camera images.

The current camera image is a camera image (image) from which a vanishing point is to be calculated henceforward. Vanishing point calculator 140 calculates, for example, every time feature extractor 110 obtains a camera image, the coordinates of a vanishing point of the obtained camera image. Information indicating the coordinates of calculated vanishing points is stored in storage 170 as vanishing point data, for example. Vanishing point calculator 140 calculates, using, for example, coordinates of vanishing points calculated in the past, the moving average (i.e., mean value) of the coordinates of the vanishing points in the past camera images. Note that the number of coordinates of the vanishing points to be used for calculating the moving average is to be optionally determined. For example, vanishing point calculator 140 calculates the moving average using coordinates of N (N is an integer of two or more) vanishing points most recently calculated.

For example, when coordinates of the vanishing point in the current camera image and the moving average of coordinates of the vanishing points in the past camera images are present within a predetermined range, vanishing point calculator 140 calculates, as the first coordinates, the moving average of coordinates of vanishing points in camera images including the coordinates of the vanishing point in the current camera image. In other words, when coordinates of the current vanishing point and the moving average of the coordinates of past vanishing points are close, vanishing point calculator 140 calculates the moving average using, as well, the coordinates of the vanishing point in the current camera image, and treats the calculated moving average as the coordinates of the vanishing point in the current camera image.

In contrast to the above, when the coordinates of the vanishing point in the current camera image and the moving average of the coordinates of the vanishing points in the past camera images are not present within the predetermined range, vanishing point calculator 140 calculates, as the first coordinates, the moving average of the coordinates of the vanishing points in the past camera images. In other words, vanishing point calculator 140 treats, as is, the moving average of the coordinates of the past vanishing points as the coordinates of the vanishing point in the current camera image, when the coordinates of the current vanishing point and the moving average of coordinates of past vanishing points are present apart from each other.

As described above, when coordinates of the current vanishing point are not present within a predetermined range from the moving average (mean value) of coordinates of past vanishing points, vanishing point calculator 140 adopts the moving average of the coordinates of the past vanishing points as the coordinates of the current vanishing point, disregarding the calculated coordinates of the current vanishing point, and only when the coordinates of the current vanishing point are present within the predetermined range, vanishing point calculator 140 recalculates the moving average using the calculated coordinates of the current vanishing point and adopts the recalculated moving average as the first coordinates.

Note that when coordinates of the current vanishing point are not present within a predetermined range from the moving average of coordinates of past vanishing points, vanishing point calculator 140 may refer to the moving average of the coordinates of the past vanishing points excluding the coordinates of the current vanishing point when the moving average of the coordinates of the past vanishing points is calculated for calculating the first coordinates in a camera image obtained subsequent to the current camera image. Moreover, when coordinates of the current vanishing point are not present within a predetermined range from the moving average of coordinates of past vanishing points, vanishing point calculator 140 may use, as is, the calculated coordinates of the current vanishing point. In addition, irrespective of the moving average of coordinates of past vanishing points, vanishing point calculator 140 may use, as is, the calculated coordinates of the current vanishing point as the first coordinates, for example.

Note that the predetermined range may be optionally determined, and thus is not particularly limited. The predetermined range is determined, for example, like the moving average of coordinates of past vanishing points ±M (M denotes an optional value indicating coordinates).

Difference calculator 150 is a processing unit that calculates a difference between calculated first coordinates and predetermined second coordinates. The first coordinates are, for example, the coordinates of a point indicated as the “vanishing point” in FIG. 2. These coordinates are determined as, for example, the first target coordinates. Moreover, the second coordinates are optionally predetermined coordinates, and are the second target coordinates in the example shown in FIG. 2. In the present embodiment, a difference is, for example, a distance between the first target coordinates and the second target coordinates in the y-axis direction.

Position corrector 160 is a processing unit that corrects, based on a calculated difference, the position of a display area in a camera image to be displayed on display device 310. In other words, position corrector 160 determines the position of a display area in a camera image to be displayed on display device 310. Position corrector 160 causes display device 310 to display an image (also referred to as a display image) of the determined display area in the camera image.

For example, as illustrated in FIG. 2, suppose that the second display area and the second target coordinates are predetermined. In addition, suppose that the coordinates of the vanishing point are calculated at the position shown in FIG. 2 by vanishing point calculator 140. In this case, position corrector 160 shifts the second display area such that the second target coordinates coincide with the vanishing point, or stated differently, such that the second target coordinates coincide with the first target coordinates. The second display area that has been shifted as described above is shown as a first display area in FIG. 3. For example, the second target coordinates are determined at a position relative to the second display area. For this reason, when the second target coordinates are shifted to coincide with the vanishing point, the second display area can be shifted to an appropriate position.

Note that when a display area is repeatedly corrected (shifted), the second target coordinates may be coordinates of a previous vanishing point and the second display area may be in the position of a previously corrected (shifted) display area.

Moreover, position corrector 160 may cause display device 310 to display a display area in a camera image such that the position of the display area changes at a predetermined rate expressed in seconds per pixel by correcting the position of the display area. For example, when second target coordinates and the coordinates of the vanishing point are present apart from each other, a display area is caused to shift greatly. Here, an abruptly shifted display area may cause discomfort, or in other words, an abruptly shifted display area may cause discomfort for users viewing the display image displayed on display device 310. In view of the above, position corrector 160 takes a time to slowly shifts the display area when the display area is changed so as to prevent users from feeling discomfort.

Note that the predetermined rate in seconds per pixel may be optionally determined, and thus is not particularly limited. The predetermined rate in seconds per pixel is determined, for example, like 10 milliseconds per pixel to 100 milliseconds per pixel. With this, when a display area is shifted, display device 310 displays a display image whose display area shifts by one pixel for every lapse of 10 milliseconds to 100 milliseconds, for example.

Each of the processing units, such as feature extractor 110, Hough transformer 120, straight line detector 130, vanishing point calculator 140, difference calculator 150, and position corrector 160, is implemented by, for example, memory that stores control programs and a processor such as the central processing unit (CPU) that executes the control programs. The processors of the processing units may be collectively implemented by a single memory and a single processor or may be individually implemented by a memory and a processor.

Storage 170 is a storage device that stores various types of information. Storage 170 stores, for example, the following information items: features extracted by feature extractor 110; Hough data indicating transform results obtained by Hough transformer 120; vanishing point data indicating coordinates (first coordinates) of vanishing points calculated by vanishing point calculator 140; information indicating thresholds such as the first information and second information; information indicating target coordinates; and the sizes and shapes of display areas. Storage 170 is implemented by, for example, a semiconductor memory, hard disk drive (HDD), or the like.

### [Processing Procedure]

Next, a processing procedure carried out by display video correction device 100 according to the embodiment will be described.

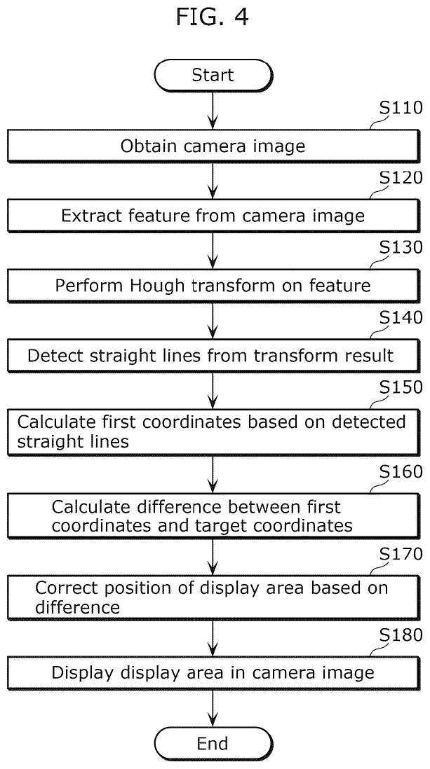

FIG. 4 is a flowchart illustrating a display video correction method according to the embodiment. For example, display video correction device 100 includes a processor and memory, and performs the following processes using the processor and memory.

First feature extractor 110 obtains a camera image from in-vehicle camera 300 (S110).

Next, feature extractor 110 extracts a feature from the camera image obtained from in-vehicle camera 300 (S120).

Next, Hough transformer 120 performs Hough transform on the extracted feature (S130).

Next, straight line detector 130 detects a plurality of straight lines in the camera image, based on a transform result of the Hough transform (S140).

Next, vanishing point calculator 140 calculates first coordinates indicating the coordinates of a vanishing point in the camera image, based on the plurality of detected straight lines (S150).

Next, difference calculator 150 calculates a difference between the calculated first coordinates (coordinates of the vanishing point) and predetermined second coordinates (target coordinates) (S160).

Next, position corrector 160 corrects, based on the calculated difference, the position of a display area in the camera image to be displayed on display device 310 (S170).

Next, position corrector 160 causes display device 310 to display the corrected display area in the camera image (S180).

Display video correction device 100 performs, for example, every time a camera image is obtained from in-vehicle camera 300, the processes of steps S110 through S170. For example, in steps S170 and S180, display video correction device 100 causes display device 310 to display an image (display image) while gradually changing the position of the display area such that the display image displayed on display device 310 is set to a position of the corrected display area in the camera image.

### Advantageous Effects, Etc.

As has been described above, display video correction device 100 according to the present embodiment includes: feature extractor 110 that extracts a feature from a camera image obtained from in-vehicle camera 300; Hough transformer 120 that performs Hough transform on the feature extracted; straight line detector 130 that detects a plurality of straight lines in the camera image, based on a transform result of the Hough transform performed; vanishing point calculator 140 that calculates, based on the plurality of straight lines detected, first coordinates indicating coordinates of a vanishing point in the camera image; difference calculator 150 that calculates a difference between the first coordinates calculated and predetermined second coordinates; and position corrector 160 that corrects, based on the difference calculated, a position of a display area in the camera image to be displayed on display device 310.

According to the above, even if in-vehicle camera 300 is changed from a desired position and a desired orientation, an appropriate position of a camera image obtained from in-vehicle camera 300 can be readily displayed on display device 310, without changing the position and orientation of in-vehicle camera 300. As described, the display extraction position (display area) of a camera image captured by in-vehicle camera 300 is changed such that the position (coordinates) of the vanishing point is shifted to an appropriate y-coordinate position as shown in FIG. 2. This allows a display image to be displayed as if in-vehicle camera 300 is corrected by changing the pitch angle. Accordingly, a camera image obtained from in-vehicle camera 300 can be readily corrected such that an appropriate area in the camera image is displayed on display device 310.

Moreover, for example, straight line detector 130 detects the plurality of straight lines based on a total number of votes calculated based on the transform result and at least one of (i) first information indicating a minimum number of votes to be detected as a straight line by the straight line detector or (ii) second information indicating a total number of straight lines to be detected by the straight line detector. The first information and the second information have been determined for each of areas in a ρ-θ space of the transform result.

According to the above, an appropriate number of straight lines can be readily detected based on at least one of the first information or the second information when the vanishing point is calculated.

In addition, for example, vanishing point calculator 140 calculates (i) coordinates of the vanishing point in a current camera image, based on the plurality of straight lines detected, where the current camera image is the camera image and (ii) the first coordinates, based on the coordinates of the vanishing point in the current camera image and a moving average of coordinates of vanishing points in past camera images, where the vanishing points each is the vanishing point and the past camera images each is the camera image.

According to the above, coordinates of vanishing points calculated in the past are also referenced for calculation of the first coordinates, namely coordinates to be finally calculated as coordinates of the current vanishing point. Accordingly, when, for example, a camera image is captured whose captured position greatly differs from camera images captured in the past due to a temporary effect such as vibration of a vehicle provided with in-vehicle camera 300, the moving average of past vanishing points will be used to determine the first coordinates. With this, it is possible to prevent an unnecessarily great change in the position of a display area due to an unintended, great change in the coordinates of the vanishing points calculated in the past.

Furthermore, for example, when the coordinates of the vanishing point in the current camera image and the moving average of the coordinates of the vanishing points in the past camera images are present within a predetermined range, vanishing point calculator 140 calculates, as the first coordinates, a moving average of coordinates of the vanishing points in camera images including the coordinates of the vanishing point in the current camera image.

According to the above, it is possible to prevent an unnecessarily great change in the position of a display area due to an unintended, great change in the coordinates of the vanishing points calculated in the past.

Moreover, for example, vanishing point calculator 140 calculates (i) coordinates of an intersection point of two straight lines selected from among the plurality of straight lines in a round-robin manner and (ii) the first coordinates, based on an average of coordinates of a plurality of intersection points each of which is the intersection point calculated.

According to the above, the vanishing point can be accurately calculated.

In addition, for example, among combinations of two straight lines selected from among the plurality of straight lines in the round-robin manner, vanishing point calculator 140 calculates the coordinates of the intersection point for only a combination of two straight lines having opposite reciprocal slopes in the image coordinate system of the camera image, where one of the two straight lines has a positive slope and the other of the two straight lines has a negative slope.

For example, when coordinates of the intersection point of two straight lines whose slopes are similar like they are approximately parallel to each other are calculated, the coordinates that contains a great error and is greatly different from coordinates of the vanishing point may be calculated. In view of the above, combinations of such two straight lines are removed from intersection point calculations to reduce the amount of processing. With this, the vanishing point can be more accurately calculated.

Furthermore, for example, position corrector 160 causes display device 310 to display the display area in the camera image in a manner that the position of the display area changes at a predetermined rate expressed in seconds per pixel by correcting the position of the display area.

According to the above, abrupt changes in camera images displayed on display device 310 can be prevented. Accordingly, users are prevented from feeling discomfort when the camera images displayed on display device 310 are viewed by the users. With this, the users are allowed to view the display images with ease.

Moreover, for example, a display video correction method according to the present embodiment includes: extracting a feature from a camera image obtained from in-vehicle camera 300 (S120); performing Hough transform on the feature extracted (S130); detecting a plurality of straight lines in the camera image, based on a transform result of the Hough transform performed (S140); calculating, based on the plurality of straight lines detected, first coordinates indicating coordinates of a vanishing point in the camera image (S150); calculating a difference between the first coordinates calculated (coordinates of the vanish point) and predetermined second coordinates (target coordinates) (S160); and correcting, based on the difference calculated, a position of a display area in the camera image to be displayed on display device 310 (S170).

The above produces the same advantageous effects as the advantageous effects produced by display video correction device 100 according to the present embodiment.

In addition, for example, a program according to the present embodiment is a program for causing a computer to execute the display video correction method according to the present embodiment.

According to the above, the same advantageous effects as the advantageous effects produced by display video correction device 100 according to the present embodiment are produced.

### Embodiment 2

Next, a display video correction device according to Embodiment 2 will be described. Note that the following mainly describe differences from the display video correction device according to Embodiment 1. Display video correction device 100 according to Embodiment 2 converts coordinates.

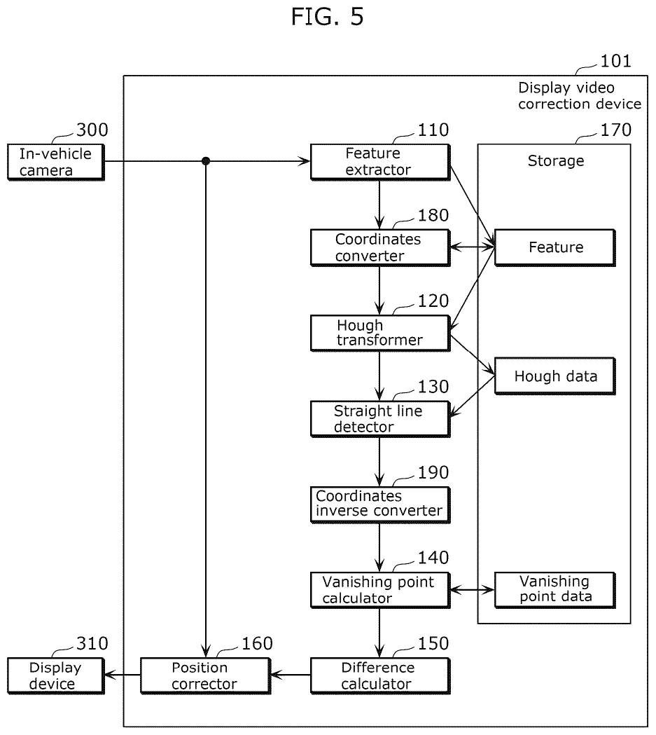

FIG. 5 is a block diagram illustrating a configuration of display video correction device 101 according to the present embodiment.

Display video correction device 101 further includes coordinates converter 180 and coordinates inverse converter 190, in addition to the elements included in display video correction device Specifically, display video correction device 101 includes feature extractor 110, coordinates converter 180, Hough transformer 120, straight line detector 130, coordinates inverse converter 190, vanishing point calculator 140, difference calculator 150, position corrector 160, and storage 170.

Coordinates converter 180 is a processing unit that converts coordinates of a feature extracted by feature extractor 110 from a first coordinate system that is an image coordinate system of camera images into coordinates in a second coordinate system whose origin point is at a position different from the position of the origin point of the first coordinate system.

The first coordinate system and second coordinate system each are, for example, a two-dimensional orthogonal coordinate system consisting of the x-axis and y-axis. The x-axis direction is, for example, a row direction of a plurality of pixels in camera images, and the y-axis direction is, for example, a column direction of the plurality of pixels in the camera images.

As described above, the first coordinate system is, for example, an image coordinate system of camera images. The image coordinate system is, for example, a coordinate system whose origin point is at the position of the upper left pixel of the camera images, assuming that the entirety of each camera image is to be displayed on display device 310. In the image coordinate system, the positive direction of the x-axis is the rightward direction from the above-mentioned pixel, and the positive direction of the y-axis is the downward direction from the above-mentioned pixel.

The second coordinate system is a coordinate system in which the position of the origin point in the first coordinate system has been changed.

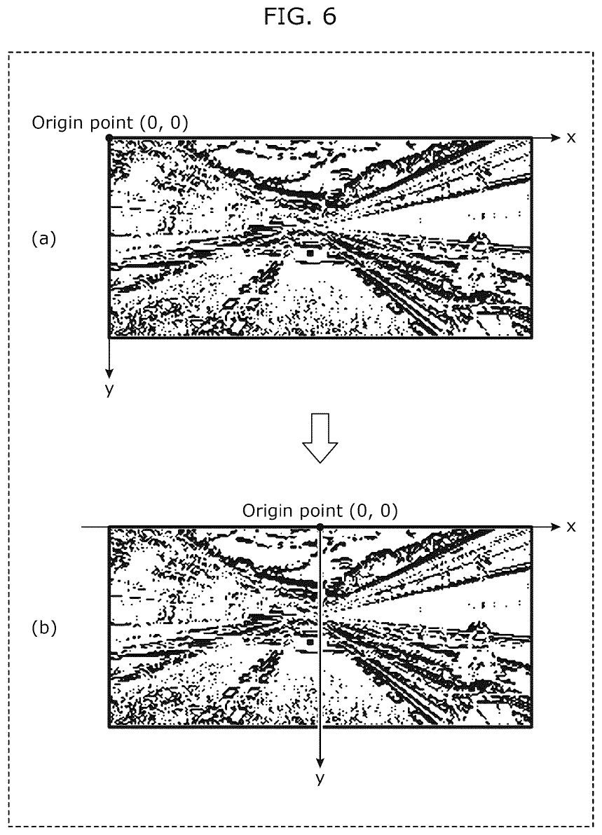

FIG. 6 through FIG. 8 are diagrams for explaining processes performed by coordinates converter 180 to change the position of the origin point of the first coordinate system.

FIG. 6 is a diagram for explaining example 1 of an origin point change according to the present embodiment. Specifically, (a) of FIG. 6 is a diagram illustrating the first coordinate system, and (b) of FIG. 6 is a diagram illustrating the second coordinate system.

As illustrated in FIG. 6, coordinates converter 180 changes, for example, the position of the origin point in the x-axis direction in the first coordinate system to the center of the x-axis direction in a camera image. In other words, in the present example, the second coordinate system is a coordinate system in which the position of the origin point in the x-axis direction in the first coordinate system is set to the center of the x-axis direction in a camera image. Coordinates converter 180 converts coordinates of a feature (i.e., a plurality of feature points) in accordance with the position of the origin point that has been changed as described above.

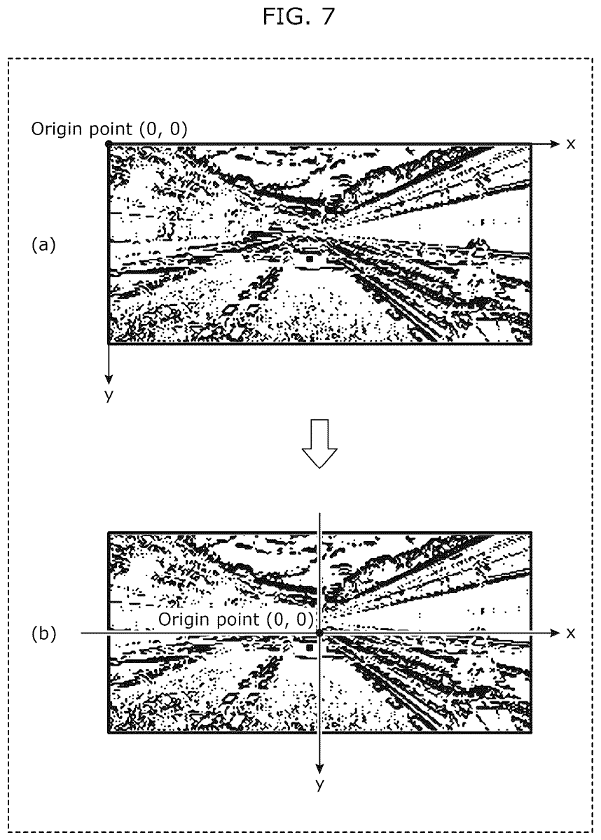

FIG. 7 is a diagram for explaining example 2 of the origin point change according to the present embodiment. Specifically, (a) of FIG. 7 is a diagram illustrating the first coordinate system, and (b) of FIG. 7 is a diagram illustrating the second coordinate system.

As illustrated in FIG. 7, coordinates converter 180 changes, for example, the position of the origin point in the first coordinate system to the center of a camera image. In other words, in the present example, the second coordinate system is a coordinate system in which the position of the origin point in the first coordinate system is set to the center of the camera image. Coordinates converter 180 converts coordinates of a feature in accordance with the position of the origin point that has been changed as described above.

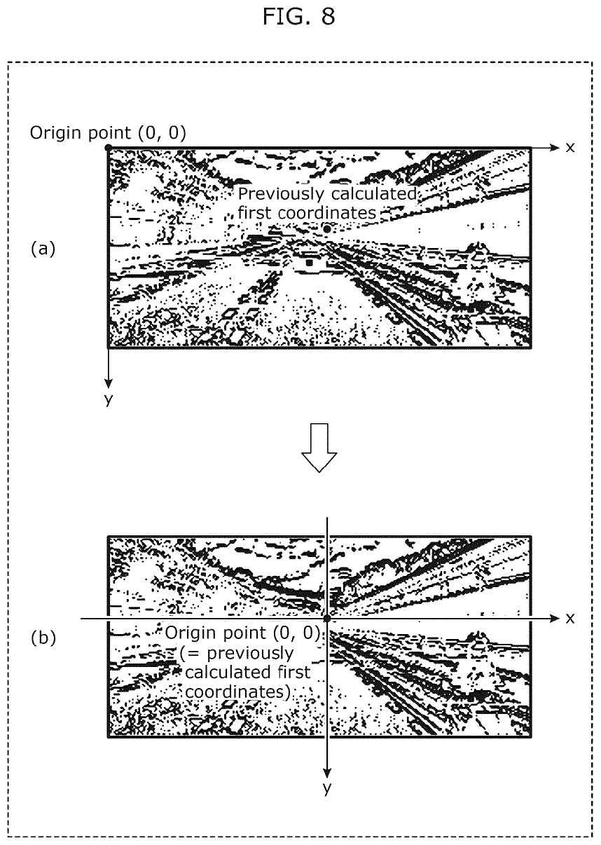

FIG. 8 is a diagram for explaining example 3 of the origin point change according to the present embodiment. Specifically, (a) of FIG. 8 is a diagram illustrating the first coordinate system, and (b) of FIG. 8 is a diagram illustrating the second coordinate system.

As illustrated in FIG. 8, coordinates converter 180 changes, for example, the position of the origin point in the first coordinate system to the position of coordinates (first coordinates) of a previously calculated vanishing point. In other words, in the present example, the second coordinate system is a coordinate system whose origin point is set to the position of the previously calculated first coordinates. Note that the previously calculated first coordinates are the first coordinates of a camera image obtained one before the current camera image. Coordinates converter 180 converts coordinates of a feature in accordance with the position of the origin point that has been changed as described above.

In the present example, Hough transformer 120 performs Hough transform on a feature converted into the second coordinate system. Moreover, in the present example, straight line detector 130 detects coordinates of a plurality of straight lines in the second coordinate system.

Coordinates inverse converter 190 is a processing unit that converts coordinates of a plurality of detected straight lines in the second coordinate system into coordinates in the first coordinate system. In other words, coordinates inverse converter 190 restores the coordinate system converted by coordinates converter 180 to the original coordinate system in a camera image.

In the present example, vanishing point calculator 140 calculates first coordinates based on coordinates of a plurality of straight lines converted into coordinates in the first coordinate system.

Each of the processing units, such as coordinates converter 180 and coordinates inverse converter 190, is implemented by, for example, memory that stores control programs and a processor such as the CPU that executes the control programs. The processors of the processing units may be collectively implemented by a single memory and a single processor or may be individually implemented by a memory and a processor.

In the present example, coordinates converter 180 converts, following step S120 shown in FIG. 4, coordinates of an extracted feature from the first coordinate system that is an image coordinate system of a camera image into coordinates in the second coordinate system whose origin point is at a position different from the position of the origin point of the first coordinate system.

Moreover, in the present example, Hough transformer 120 performs, in step S130, following the above-described process, Hough transform on the feature whose coordinates have been changed by coordinates converter 180.

In addition, in the present example, straight line detector 130 detects, in step S140, following the above-described process, a plurality of straight lines in a camera image based on a transform result of the Hough transform. In this case, coordinates of the straight lines to be detected are the coordinates in the second coordinate system.

Moreover, in the present example, coordinates inverse converter 190 converts, following the above-described process, the coordinates of the plurality of straight lines detected by straight line detector 130 in the second coordinate system into coordinates in the first coordinate system.

In addition, in the present example, processes from step S150 onward will be performed following the above-described process.

As has been described above, in addition to the elements included in display video correction device 100, display video correction device 101 according to the present embodiment further includes, for example, coordinates converter 180 that converts coordinates of the feature extracted from a first coordinate system into coordinates in a second coordinate system, where the first coordinate system is an image coordinate system of the camera image and the second coordinate system is a coordinate system whose origin point is at a position different from a position of an origin point of the first coordinate system, and coordinates inverse converter 190 that converts coordinates of the plurality of straight lines detected in the second coordinate system into coordinates in the first coordinate system. In display video correction device 101: Hough transformer 120 performs the Hough transform on the feature converted into the second coordinate system; straight line detector 130 detects the coordinates of the plurality of straight lines in the second coordinate system; and vanishing point calculator 140 calculates the first coordinates based on the coordinates of the plurality of straight lines converted into the coordinates in the first coordinate system.

As described above, in the image coordinate system, the origin point is at the upper left of a camera image. In other words, in the first coordinate system, the origin point is positioned at an end portion of a camera image. Whereas, in the second coordinate system in which the position of the origin point has been converted, the origin point is positioned closer to the center portion of a camera image than the origin point of the first coordinate system is. As described above, appropriately determining the position of the origin point in accordance with each of processes of Hough transform, straight line detection, and vanishing point calculation can reduce an amount of processing performed for each of the processes of the Hough transform, straight line detection, and vanishing point calculation.

Moreover, for example, the second coordinate system is a coordinate system in which a position of the origin point in an x-axis direction in the first coordinate system is set to the center of the x-axis direction in the camera image.

According to the above, an amount of processing performed for each of the processes of the Hough transform, straight line detection, and vanishing point calculation can be reduced.

In addition, for example, the second coordinate system is a coordinate system in which a position of the origin point in the first coordinate system is set to the center of the camera image.

According to the above, an amount of processing performed for each of processes of Hough transform, straight line detection, and vanishing point calculation can be reduced.

Furthermore, for example, the second coordinate system is a coordinate system in which a position of the origin point in the first coordinate system is set to a position of the first coordinates previously calculated.

According to the above, an amount of processing performed for each of the processes of the Hough transform, straight line detection, and vanishing point calculation can be reduced.

### Embodiment 3

Next, a display video correction device according to Embodiment 3 will be described. Note that the following mainly describe differences from the display video correction devices according to Embodiments 1 and 2. A display video correction device according to Embodiment 3 performs image processing on a camera image obtained from in-vehicle camera 300, before a feature is extracted.

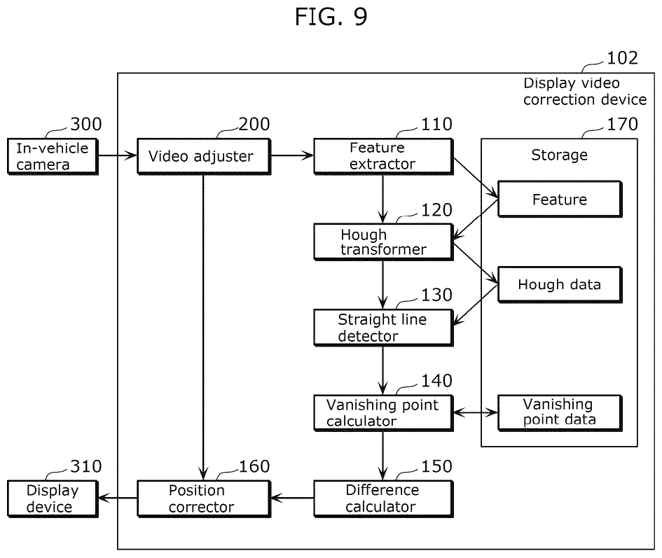

FIG. 9 is a block diagram illustrating a configuration of display video correction device 102 according to the present embodiment.

Display video correction device 102 further includes video adjuster 200, in addition to the elements included in display video correction device 100. Specifically, display video correction device 102 includes video adjuster 200, feature extractor 110, Hough transformer 120, straight line detector 130, vanishing point calculator 140, difference calculator 150, position corrector 160, and storage 170.

Video adjuster 200 is a processing unit that performs image processing on a camera image obtained from in-vehicle camera 300, before a feature is extracted. In the present example, feature extractor 110 obtains a camera image that has been adjusted by video adjuster 200, and extracts a feature from the obtained camera image.

For example, video adjuster 200 corrects distortions in camera images caused by a lens included in in-vehicle camera 300. An optional method may be adopted for the process to be performed by video adjuster 200 on camera images to correct distortions caused by the lens included in in-vehicle camera 300. For example, video adjuster 200 corrects a distortion in a camera image caused by the lens included in in-vehicle camera 300 by correcting deformation using a matrix transformation (projective transformation). Moreover, for example, video adjuster 200 corrects a distortion in a camera image caused by the lens included in in-vehicle camera 300 by using a machine learning model trained by deep learning techniques, etc. For example, the machine learning model is trained to use a camera image as an input to output a corrected camera image in which a distortion caused by the lens included in in-vehicle camera 300 has been corrected. Video adjuster 200, for example, corrects a camera image obtained from in-vehicle camera 300 by inputting the camera image obtained from in-vehicle camera 300 into the machine learning model and obtaining a corrected camera image output from the machine learning model. Note that an optional method may be adopted for training the machine learning model. The machine learning model is stored in, for example, storage 170.

In the present example, feature extractor 110 extracts a feature from a camera image corrected by video adjuster 200.

Note that video adjuster 200 may reduce the size (perform thinning) of camera images obtained from in-vehicle camera 300 to convert the camera images into grayscale images (grayscale video). Video adjuster 200 reduce the size of camera images using, for example, nearest neighbor interpolation, bilinear interpolation, or bicubic interpolation. Moreover, for example, video adjuster 200 converts camera images into grayscale images using an average method, weighted average method, luminance method, etc.

Note that the order of video adjuster 200 reducing the size of camera images obtained from in-vehicle camera 300 and converting the camera images into grayscale images is optional. For example, video adjuster 200 reduces the size of camera images obtained from in-vehicle camera 300 and converts the reduced camera images into grayscale images.

When video adjuster 200 reduces the size of camera images obtained from in-vehicle camera 300 and converts the camera images into grayscale images, feature extractor 110 extracts features from the camera images reduced in size and converted into grayscale images.

Note that video adjuster 200 may (i) correct distortions in camera images obtained from in-vehicle camera 300 caused by the lens included in in-vehicle camera 300, (ii) reduce the size of the camera images, and (iii) convert the camera images into grayscale images. The above-described image processing steps may be performed in an optional order.

As described above, video adjuster 200 performs at least any one of following processes: (i) correction of a distortion in a camera image obtained from in-vehicle camera 300 caused by the lens included in in-vehicle camera 300, (ii) reduction of the size of the camera image obtained from in-vehicle camera 300, or (iii) conversion of the camera image obtained from in-vehicle camera 300 into a grayscale image. Video adjuster 200 is one example of a video corrector and/or a video converter. Video adjuster 200 may have one or both of (i) functions performed by the video corrector and (ii) functions performed by the video converter.

Each of the processing units, such as video adjuster 200, is implemented by, for example, memory that stores control programs and a processor such as the CPU that executes the control programs. The processors of the processing units may be collectively implemented by a single memory and a single processor or may be individually implemented by a memory and a processor.

In the present example, video adjuster 200 performs step S110 shown in FIG. 4, and performs, following step S110, image processing on the obtained camera image, such as correction of a distortion caused by the lens included in in-vehicle camera 300.

Moreover, in the present example, feature extractor 110 extracts, in step S120, following the above-described process, a feature from the camera image on which the image processing has been performed by video adjuster 200.

In addition, in the present example, processes from step S130 onward will be performed following the above-described process.

As has been described above, in addition to the elements included in display video correction device 100, display video correction device 102 according to the present embodiment further includes, for example, a video corrector that corrects a distortion in the camera image caused by a lens included in in-vehicle camera 300. In display video correction device 102, feature extractor 110 extracts the feature from the camera image corrected by the video corrector. The above-described video adjuster 200 is one example of the video corrector.

According to the above, feature extractor 110 can accurately extract a feature.

Moreover, for example, display video correction device 102 may further includes a video converter that reduces a size of the camera image and converts the camera image into a grayscale image. In display video correction device 102, feature extractor 110 may extract the feature from the camera image reduced in size and converted into the grayscale image. Video adjuster 200 is one example of the video converter.

According to the above, an amount of processing to extract a feature can be reduced.

### Embodiment 4

Next, a display video correction device according to Embodiment 4 will be described. Note that the following mainly describe differences from the display video correction devices according to Embodiments 1 through 3. A display video correction device according to Embodiment 4 performs processes that the display video correction device according to Embodiment 2 performs and processes that the display video correction device according to Embodiment 3 performs.

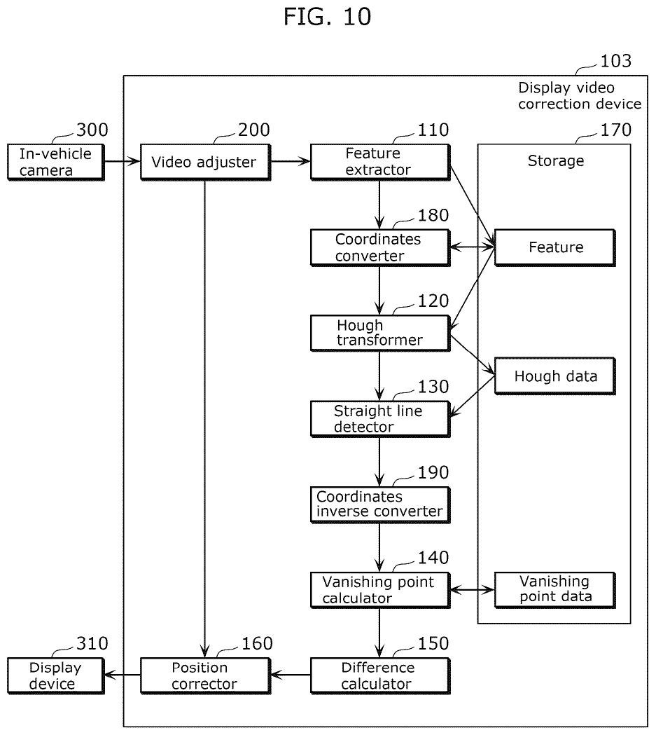

FIG. 10 is a block diagram illustrating a configuration of display video correction device 103 according to the present embodiment.

Display video correction device 103 further includes coordinates converter 180, coordinates inverse converter 190, and video adjuster 200, in addition to the elements included in display video correction device 100. Specifically, display video correction device 103 includes video adjuster 200, feature extractor 110, coordinates converter 180, Hough transformer 120, straight line detector 130, coordinates inverse converter 190, vanishing point calculator 140, difference calculator 150, position corrector 160, and storage 170.

As described, the display video correction device according to one aspect of the present disclosure may be implemented by optionally combining the elements included in the display video correction devices according to the embodiments.

In the present example, video adjuster 200 performs step S110 shown in FIG. 4, and performs, following step S110, image processing on an obtained camera image, such as correction of a distortion caused by a lens included in in-vehicle camera 300.

Moreover, in the present example, feature extractor 110 extracts, in step S120, following the above-described process, a feature from the camera image on which the image processing has been performed by video adjuster 200.

In addition, in the present example, coordinates converter 180 converts, following the above-described process, coordinates of an extracted feature in the first coordinate system that is an image coordinate system of a camera image into coordinates in the second coordinate system whose origin point is at a position different from the position of the origin point of the first coordinate system.

Moreover, in the present example, Hough transformer 120 performs, in step S130, following the above-described process, Hough transform on a feature whose coordinates have been changed by coordinates converter 180.

In addition, in the present example, straight line detector 130 detects, in step S140, following the above-described process, a plurality of straight lines in the camera image based on a transform result of the Hough transform. In this case, coordinates of the straight lines to be detected are coordinates in the second coordinate system.

Moreover, in the present example, coordinates inverse converter 190 converts, following the above-described process, the coordinates of the plurality of straight lines detected by straight line detector 130 in the second coordinate system into coordinates in the first coordinate system.

In addition, in the present example, processes from step S150 onward will be performed following the above-described process.

### Other Embodiments

As has been described above, embodiments have been described as examples of techniques according to the present disclosure. However, the techniques according to the present disclosure are not limited to the above embodiments and are applicable to embodiments to which changes, replacements, additions, omissions, etc., are made. For example, the present disclosure encompasses, as embodiments, the following variations.

The size and shape of a display area is determined in accordance with the size and shape of a display surface on which display device 310 displays camera images, but may be optional. Moreover, correcting the position of a display area indicates shifting the position of the display area without changes in size and shape of the display area, but the size and/or shape of the display area may further be changed when the display area is corrected.

In addition, in the above-described embodiments, the display area is shifted only in the y-axis direction, but the display area may be shifted only in the x-axis direction or may be shifted in the x-axis direction and y-axis direction.

Moreover, when, for example, the present disclosure is implemented by a program (software program), each of the steps is executed by executing the program using hardware resources such as the CPU, memory, and an input/output circuit of a computer. In other words, each step is executed by the CPU (i) obtaining data from the memory or the input-output circuit and calculating the data and (ii) outputting a calculation result to the memory or the input/output circuit.

Such program may be executed by a single computer or by a plurality of computers. In other words, either the central processing or distributed processing may be performed.

Note that, in the above-described embodiments, each of elements included in display video correction devices 100 through 103 may be configured in the form of an exclusive hardware product or by executing a software program suitable for the element. Each element may be implemented as a result of a program execution unit, such as the CPU, processor or the like, loading and executing a software program stored in a recording medium such as a hard disk or a semiconductor memory.

Some or all of functions of display video correction devices 100 through 103 according to the above-described embodiments are typically implemented as a large-scale integration (LSI) circuit, which is an integrated circuit. These circuits each may be individually implemented as a single chip or may be implemented as a single chip including some or all of the circuits. Moreover, circuit integration is not limited to LSI; circuit integration may be implemented by a dedicated circuit or generic processor. A field programmable gate array (FPGA) that can be programmed after the manufacturing of the LSI circuit, or a reconfigurable processor that allows the reconfiguration of the connection and setting of a circuit cell inside the LSI circuit may be used.

Furthermore, when technology for circuit integration that replaces LSI is developed as a result of advancements of or derivatives from the semiconductor technology, such technology may be used as a matter of course to integrate circuits of the elements included in display video correction devices 100 through 103.

Moreover, in the above-described embodiments, a process performed by a particular processing unit may be performed by another processing unit, for example. In addition, the order of a plurality of processes may be changed, and the plurality of processes may be performed in parallel.

Furthermore, for example, the functions of display video correction devices 100 through 103 may be carried out by in-vehicle camera 300, a vehicle, or display device 310, or may be implemented by a computer independent of the aforementioned elements.

Besides the above, the present disclosure also encompasses: embodiments achieved by applying various modifications conceivable to those skilled in the art to each of the embodiments; and
embodiments achieved by optionally combining the elements and the functions of each of the embodiments without departing from the spirit of the present disclosure.

### Supplementary Notes

The above-described embodiments disclose the following techniques.

### [Technical Aspect 1]

A display video correction device includes: a feature extractor that extracts a feature from a camera image obtained from an in-vehicle camera; a Hough transformer that performs Hough transform on the feature extracted; a straight line detector that detects a plurality of straight lines in the camera image, based on a transform result of the Hough transform performed; a vanishing point calculator that calculates, based on the plurality of straight lines detected, first coordinates indicating coordinates of a vanishing point in the camera image; a difference calculator that calculates a difference between the first coordinates calculated and predetermined second coordinates; and a position corrector that corrects, based on the difference calculated, a position of a display area in the camera image to be displayed on a display device.

According to the above, even if the in-vehicle camera is changed from a desired position and a desired orientation, an appropriate position of a camera image obtained from the in-vehicle camera can be readily displayed on the display device, without changing the position and orientation of the in-vehicle camera. Accordingly, a camera image obtained from the in-vehicle camera can be readily corrected such that an appropriate area in the camera image is displayed on the display device.

### [Technical Aspect 2]

The display video correction device according to technical aspect 1, further includes: a coordinates converter that converts coordinates of the feature extracted from a first coordinate system into coordinates in a second coordinate system, where the first coordinate system is an image coordinate system of the camera image and the second coordinate system is a coordinate system whose origin point is at a position different from a position of an origin point of the first coordinate system; and a coordinates inverse converter that converts coordinates of the plurality of straight lines detected in the second coordinate system into coordinates in the first coordinate system. In the display video correction device according to technical aspect 1: the Hough transformer performs the Hough transform on the feature converted into the second coordinate system; the straight line detector detects the coordinates of the plurality of straight lines in the second coordinate system; and the vanishing point calculator calculates the first coordinates based on the coordinates of the plurality of straight lines converted into the coordinates in the first coordinate system.

According to the above, appropriately determining the position of the origin point can reduce an amount of processing performed for each of processes of Hough transform, straight line detection, and vanishing point calculation.

### [Technical Aspect 3]

The display video correction device according to technical aspect 1 or 2, further includes a video corrector that corrects a distortion in the camera image caused by a lens included in the in-vehicle camera. In the display video correction device according to technical aspect 1 or 2, the feature extractor extracts the feature from the camera image corrected by the video corrector.

According to the above, a feature can be accurately extracted.

### [Technical Aspect 4]

In the display video correction device according to any one of technical aspects 1 to 3, the straight line detector detects the plurality of straight lines based on a total number of votes calculated based on the transform result and at least one of (i) first information indicating a minimum number of votes to be detected as a straight line by the straight line detector or (ii) second information indicating a total number of straight lines to be detected by the straight line detector, the first information and the second information having been determined for each of areas in a ρ-θ space of the transform result.

According to the above, an appropriate number of straight lines can be readily detected when the vanishing point is calculated.

### [Technical Aspect 5]

In the display video correction device according to technical aspect 2, the second coordinate system is a coordinate system in which a position of the origin point in an x-axis direction in the first coordinate system is set to the center of the x-axis direction in the camera image.

According to the above, an amount of processing performed for each of the processes of the Hough transform, straight line detection, and vanishing point calculation can be reduced.

### [Technical Aspect 6]

In the display video correction device according to technical aspect 2, the second coordinate system is a coordinate system in which a position of the origin point in the first coordinate system is set to the center of the camera image.

According to the above, an amount of processing performed for each of the processes of the Hough transform, straight line detection, and vanishing point calculation can be reduced.

### [Technical Aspect 7]

In the display video correction device according to technical aspect 2, the second coordinate system is a coordinate system in which a position of the origin point in the first coordinate system is set to a position of the first coordinates previously calculated.

According to the above, an amount of processing performed for each of the processes of the Hough transform, straight line detection, and vanishing point calculation can be reduced.

### [Technical Aspect 8]

The display video correction device according to any one of technical aspects 1 to 7 further includes a video converter that reduces a size of the camera image and converts the camera image into a grayscale image. In the display video correction device according to any one of technical aspects 1 to 7, the feature extractor extracts the feature from the camera image reduced in size and converted into the grayscale image.

According to the above, an amount of processing to extract a feature can be reduced.

### [Technical Aspect 9]

In the display video correction device according to any one of technical aspects 1 to 8, the vanishing point calculator calculates (i) coordinates of the vanishing point in a current camera image, based on the plurality of straight lines detected, where the current camera image is the camera image and (ii) the first coordinates, based on the coordinates of the vanishing point in the current camera image and a moving average of coordinates of vanishing points in past camera images, where the vanishing points each is the vanishing point and the past camera images each is the camera image.

According to the above, it is possible to prevent an unnecessarily great change in the position of a display area due to an unintended, great change in the coordinates of the vanishing point calculated in the past.

### [Technical Aspect 10]

In the display video correction device according to technical aspect 9, when the coordinates of the vanishing point in the current camera image and the moving average of the coordinates of the vanishing points in the past camera images are present within a predetermined range, the vanishing point calculator calculates, as the first coordinates, a moving average of coordinates of the vanishing points in camera images including the coordinates of the vanishing point in the current camera image.

According to the above, it is possible to prevent an unnecessarily great change in the position of a display area due to an unintended, great change in the coordinates of the vanishing point calculated in the past.

### [Technical Aspect 11]

In the display video correction device according to any one of technical aspects 1 to 10, the vanishing point calculator calculates (i) coordinates of an intersection point of two straight lines selected from among the plurality of straight lines in a round-robin manner and (ii) the first coordinates, based on an average of coordinates of a plurality of intersection points each of which is the intersection point calculated.

According to the above, the vanishing point can be accurately calculated.

### [Technical Aspect 12]

In the display video correction device according to technical aspect 11, among combinations of two straight lines selected from among the plurality of straight lines in the round-robin manner, the vanishing point calculator calculates the coordinates of the intersection point for only a combination of two straight lines having opposite reciprocal slopes in the image coordinate system of the camera image, where one of the two straight lines has a positive slope and the other of the two straight lines has a negative slope.

According to the above, the vanishing point can be even more accurately calculated.

### [Technical Aspect 13]

In the display video correction device according to any one of technical aspects 1 to 12, the position corrector causes the display device to display the display area in the camera image in a manner that the position of the display area changes at a predetermined rate expressed in seconds per pixel by correcting the position of the display area.

According to the above, abrupt changes in camera images displayed on a display device can be prevented. Therefore, the users are allowed to view the camera images displayed on the display device with ease.

### [Technical Aspect 14]

A display video correction method includes: extracting a feature from a camera image obtained from an in-vehicle camera; performing Hough transform on the feature extracted; detecting a plurality of straight lines in the camera image, based on a transform result of the Hough transform performed; calculating, based on the plurality of straight lines detected, first coordinates indicating coordinates of a vanishing point in the camera image; calculating a difference between the first coordinates calculated and predetermined second coordinates; and correcting, based on the difference calculated, a position of a display area in the camera image to be displayed on a display device.

The above produces the same advantageous effects as the advantageous effects produced by the display video correction device according to one aspect of the present disclosure.

### [Technical Aspect 15]

A program for causing a computer to execute the display video correction method according to technical aspect 14.

The above produces the same advantageous effects as the advantageous effects produced by the display video correction device according to one aspect of the present disclosure.

Note that these comprehensive or specific aspects of the present disclosure may be implemented by a system, a method, an integrated circuit, a computer program, or a recording medium such as a computer-readable CD-ROM, or by an optional combination of the system, the method, the integrated circuit, the computer program, and the recording medium.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to devices for controlling images to be displayed on display devices.

1. A display video correction device comprising:
a feature extractor that extracts a feature from a camera image obtained from an in-vehicle camera;
a Hough transformer that performs Hough transform on the feature extracted;
a straight line detector that detects a plurality of straight lines in the camera image, based on a transform result of the Hough transform performed;
a vanishing point calculator that calculates, based on the plurality of straight lines detected, first coordinates indicating coordinates of a vanishing point in the camera image;
a difference calculator that calculates a difference between the first coordinates calculated and predetermined second coordinates; and
a position corrector that corrects, based on the difference calculated, a position of a display area in the camera image to be displayed on a display device.

2. The display video correction device according to claim 1, further comprising:
a coordinates converter that converts coordinates of the feature extracted from a first coordinate system into coordinates in a second coordinate system, the first coordinate system being an image coordinate system of the camera image, the second coordinate system being a coordinate system whose origin point is at a position different from a position of an origin point of the first coordinate system; and
a coordinates inverse converter that converts coordinates of the plurality of straight lines detected in the second coordinate system into coordinates in the first coordinate system, wherein the Hough transformer performs the Hough transform on the feature converted into the second coordinate system,
the straight line detector detects the coordinates of the plurality of straight lines in the second coordinate system, and
the vanishing point calculator calculates the first coordinates based on the coordinates of the plurality of straight lines converted into the coordinates in the first coordinate system.

3. The display video correction device according to claim 1, further comprising:
a video corrector that corrects a distortion in the camera image caused by a lens included in the in-vehicle camera, wherein
the feature extractor extracts the feature from the camera image corrected by the video corrector.

4. The display video correction device according to claim 1, wherein
the straight line detector detects the plurality of straight lines based on a total number of votes calculated based on the transform result and at least one of (i) first information indicating a minimum number of votes to be detected as a straight line by the straight line detector or (ii) second information indicating a total number of straight lines to be detected by the straight line detector, the first information and the second information having been determined for each of areas in a ρ-θ space of the transform result.

5. The display video correction device according to claim 2, wherein
the second coordinate system is a coordinate system in which a position of the origin point in an x-axis direction in the first coordinate system is set to a center of the x-axis direction in the camera image.

6. The display video correction device according to claim 2, wherein
the second coordinate system is a coordinate system in which a position of the origin point in the first coordinate system is set to a center of the camera image.

7. The display video correction device according to claim 2, wherein
the second coordinate system is a coordinate system in which a position of the origin point in the first coordinate system is set to a position of the first coordinates previously calculated.

8. The display video correction device according to claim 1, further comprising:
a video converter that reduces a size of the camera image and converts the camera image into a grayscale image, wherein
the feature extractor extracts the feature from the camera image reduced in size and converted into the grayscale image.

9. The display video correction device according to claim 1, wherein
the vanishing point calculator calculates:
coordinates of the vanishing point in a current camera image, based on the plurality of straight lines detected, the current camera image being the camera image; and
the first coordinates, based on the coordinates of the vanishing point in the current camera image and a moving average of coordinates of vanishing points in past camera images, the vanishing points each being the vanishing point, the past camera images each being the camera image.

10. The display video correction device according to claim 9, wherein
when the coordinates of the vanishing point in the current camera image and the moving average of the coordinates of the vanishing points in the past camera images are present within a predetermined range, the vanishing point calculator calculates, as the first coordinates, a moving average of coordinates of the vanishing points in camera images including the coordinates of the vanishing point in the current camera image.

11. The display video correction device according to claim 1, wherein
the vanishing point calculator calculates:
coordinates of an intersection point of two straight lines selected from among the plurality of straight lines in a round-robin manner; and
the first coordinates, based on an average of coordinates of a plurality of intersection points each of which is the intersection point calculated.

12. The display video correction device according to claim 11, wherein
among combinations of two straight lines selected from among the plurality of straight lines in the round-robin manner, the vanishing point calculator calculates the coordinates of the intersection point for only a combination of two straight lines having opposite reciprocal slopes in the image coordinate system of the camera image, where one of the two straight lines has a positive slope and an other of the two straight lines has a negative slope.

13. The display video correction device according to claim 1, wherein
the position corrector causes the display device to display the display area in the camera image in a manner that the position of the display area changes at a predetermined rate expressed in seconds per pixel by correcting the position of the display area.

14. A display video correction method comprising:
extracting a feature from a camera image obtained from an in-vehicle camera;
performing Hough transform on the feature extracted;
detecting a plurality of straight lines in the camera image, based on a transform result of the Hough transform performed;
calculating, based on the plurality of straight lines detected, first coordinates indicating coordinates of a vanishing point in the camera image;
calculating a difference between the first coordinates calculated and predetermined second coordinates; and
correcting, based on the difference calculated, a position of a display area in the camera image to be displayed on a display device.

15. A non-transitory computer-readable recording medium for use in a computer, the recording medium having recorded thereon a computer program for causing the computer to execute the display video correction method according to claim 14.
